(19) United States
(12) Patent Application Publication
(10) Pub. No.: US 2003/0015082 A1
(43) Pub. Date: Jan. 23, 2003

(54) Method and article for creating musical instruments via plastic molding technique

(76) Inventor: Michael Brennan, Perry, OH (US)

Correspondence Address: Daniel A. Thomson, Esq., Fourteenth Floor, One Cascade Plaza, Akron, OH, 44308-1147, US

(21) Appl. No.: 09/908,536

(22) Filed: Jul. 18, 2001

(51) Int. Cl. G10D 7/00

(52) U.S. Cl. 84/380 R

(57) ABSTRACT

A new and improved method and apparatus for molding parts of musical instruments requiring conical bores. The method includes utilizing a core pin, held in the center of a mold, to create the necessary diameter and dimensions for the musical part. A core pin is removed from the core pin via a hex nut, which pushes the ejector sleeve against the part, thereby removing the part.

### I. BACKGROUND OF THE INVENTION

A. Field of the Invention

This invention relates to the art of musical instruments, and more particularly to the art of creating musical instruments, and parts of musical instruments, using a plastic molding technique. And even more particularly, to get out of creating a firmer set conical bore for an uilleann pipe.

B. Background of the Invention

Bagpipes have been played since Roman times and despite their common connotation as purely Scottish instrument, are widely played in other parts of Europe, Asia, North America, and North Africa. Bagpipes are reed instruments characterized by an air reservoir in the form of a bag that is inflated by air from a player's arm. The bag is usually made of an animal skin into which the chanter, or fingered melody pipe, and the unfingered drone pipes are inserted. The chanter and drones may be either cylindrical or conical, and have a single or double reed at their upper ends where they fit into the bag. Because the reeds are supplied with air from the bag, and not directly from the player's mouth, the player may breathe while playing resulting in an uninterrupted sound.

One type of bagpipe is the uilleann pipe, whose name derives from the Irish word-meaning elbow. Uilleann pipes typically utilize a bellows placed under one arm that inflates a bag placed under the other arm. A typical uilleann pipe includes a fingered reeded chanter drilled with eight holes, up to three reeded drone pipes and up to three keyed regulators. However, some chromatic uilleann pipe chanters may include four more keyed holes. While playing, the chanter is held such that the end of the chanter rests against the leg of the player. In this manner, the player simultaneously fills the bag with air from the bellows, pumps air from the bag through the chanter and drone pipes and manipulates the fingers over the eight holes of the changer to produce sounds.

The uilleann pipes have been played in the United States for many years, but have gained popularity of late due to their use in the soundtrack for the movie “Titanic” and in the stage production of “Riverdance.” However, many people wishing to learn to play the uilleann pipes are discouraged from doing so by their price and availability, which range from between $200 and $6500 and between 2 and 6 years to obtain a new set.

The prohibitive price of a set of pipes is due to the fact they are not massproduced and are made of an expensive wood with a very hard and tight grain. Also, a great amount of time and care must go into creating the proper dimensions for all of the different pieces.

The present invention provides a new and improved apparatus and method for manufacturing parts for musical instruments using thermoset molding and overcomes certain difficulties inherent in the-related inventions while providing better overall results.

### II. SUMMARY OF THE INVENTION

In accordance with one aspect of the present invention, a method for producing a pipe chanter includes the steps of providing a core pin with a diameter matching a required diameter for an associated bore of the uilleann chanter, applying wax to the core pin, placing the mold in an upright position, pouring urethane into the mold, securing the core pin in the center of the mold, curing for at least twenty-four hours, demolding the chanter, and rotating a hex nut, the hex nut pushing an ejector sleeve upward to remove the core pin from the chanter. By “demolding” it is meant opening the mold and removing the part.

In accordance with another aspect of the present invention, a method for producing parts for a conical bore instrument, including the steps of pouring resin into a mold and molding the instrument.

In accordance with yet another aspect of the present invention, the method also includes the steps of waxing a core pin, closing the mold around the core pin, securing the core pin in the center of the mold, curing the resin for at least twenty-four hours, and rotating a hex nut, the hex nut pushing an ejector sleeve upward to remove the core pin from the chanter or part.

In accordance with another aspect of the present invention, a musical instrument having a molded conical bore.

In accordance with another aspect of the present invention, an uilleann bagpipe includes a bellows, a chanter, a chanter reed, finger holes, key mounts, a bellows valve, a bellows stock, a blow-pipe receiver, a blow pipe, a blow pipe stock, and chanter stock, a wind cap, a wind cap top, decorative mounts, drone parts, and regulator parts, wherein at least one of the preceding is made out of thermoset resin.

In accordance with another aspect of the present invention, the afore-mentioned bagpipe pieces are all made of thermoset resin.

In accordance with another aspect of the present invention, an apparatus for use in molding parts for musical instruments, includes a core pin, an ejector sleeve slidably connected to the core pin, and ejecting means for moving the ejector sleeve up the core pin to move the molded parts.

In accordance with another aspect of the present invention, the connection between the core pin and the ejecting means is a threaded correction. However, it is to be understood that the ejecting means can be any means of removing the core pin and part from the mold, as long as chosen using sound engineering judgment.

In accordance with another aspect of the present invention, the ejecting means is a hex nut.

In accordance with another aspect of the present invention, the finger holes are molded.

Still other benefits and advantages of the invention will become apparent to those skilled in the art upon a reading and understanding of the following detailed specification.

### III. BRIEF DESCRIPTION OF DRAWINGS

The invention may take physical form in certain parts and arrangement of parts. At least one embodiment of these parts will be described in detail in the specification and illustrated in the accompanying drawings, which form a part of this disclosure and wherein:

FIG. 1 is a perspective view of a bagpipe chanter blank made using a known process;

FIG. 2 is a cross-sectional view of the bagpipe chanter blank made using a known process;

FIG. 3 is a cross-sectional view of the blowpipe stock;

FIG. 4 is a cross-sectional view of the blowpipe receiver;

FIG. 5 is a cross-sectional view of the bellows valve;

FIG. 6 is a cross-sectional perspective view of the blowpipe;

FIG. 7 is a cross-sectional view of the chanter stock;

FIG. 8 is a perspective view of the air bladder or bag;

FIG. 8A is a view of the bladder along line A-A;

FIG. 9 is a top and side view of the bellows, showing the air intake and the air exhaust;

FIG. 9A is a top and side view of the bellows in the open position;

FIG. 9B is a top and side view of the bellows in the closed position;

FIG. 10 is a graph showing the location of the keyholes and critical bore diameters on the bagpipe chanter;

FIG. 11 is a perspective view of a full set of uilleann pipes;

FIG. 12 is a side view of the chanter, showing the key mounts and finger holes;

FIG. 13 is a perspective view of the core pin, ejector sleeve, and hex nut;

FIG. 14 is a perspective view, showing the connection of the bellows to the bag;

FIG. 15A is perspective view of the key mount;

FIG. 15B is a front view of the key mount; and, FIG. 16 is a perspective view of the core pin, mold, and donut.

### IV. DESCRIPTION OF THE INVENTION

With reference now to the FIGURES, which are for illustrative purposes only, and are not intended to limit the invention in any manner, FIG. 11 shows a fall set of uilleann bagpipes 64, including a bag 42, pipes 56, chanter 58, bellows 48, blowpipe stock 32, blowpipe receiver 34, blowpipe 38, wind cap 60, wind cap top 62, drone 102, regulator 104, and chanter stock 46. The pipes 56 are connected to the bag 42 by the blowpipe stock 32, chanter stock 46, and the main stock (shown, but not referenced.) A hole is cut in the bag 42 and the blowpipe stock 32, chanter stock 46, and main stock are inserted and tied in place. Typically, a length of string is wound around the stocks, then over the edge of the hole in the bag 42, and tied to create an airtight seal.

The bellows 48 is connected to the bag 42 by a bellows tube 80, which is connected to a blowpipe receiver 34, which receives the blowpipe 38. In turn, the blowpipe 38 is connected to the blowpipe stock 32, which connects to the bag 42 as shown in FIGS. 11 and 14. The bellows 48 are used to inflate the bag 42, so that the instrument can be played. The bag 42 is compressed and air travels out of the bag 42 into the pipes 56, chanter 58, and wind cap 60. The wind cap 60 is the connection between the bag 42, via the chanter stock 46, and the chanter 58, creating an airtight protective chamber for the reed (not shown). The wind cap 60 is connected to the bagpipe 42 by the chanter stock 46.

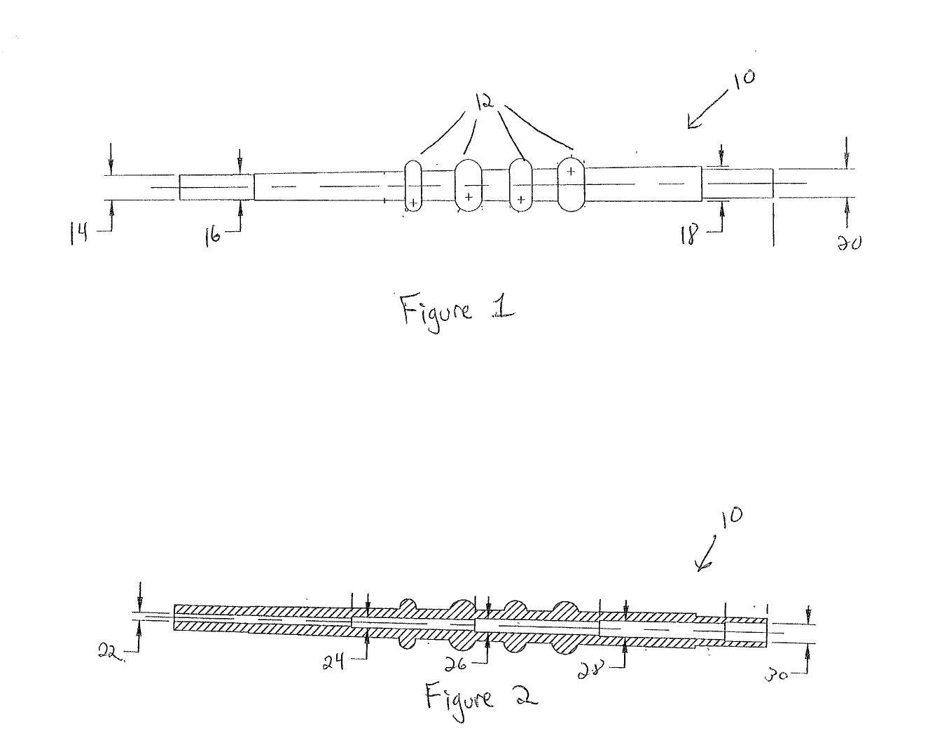

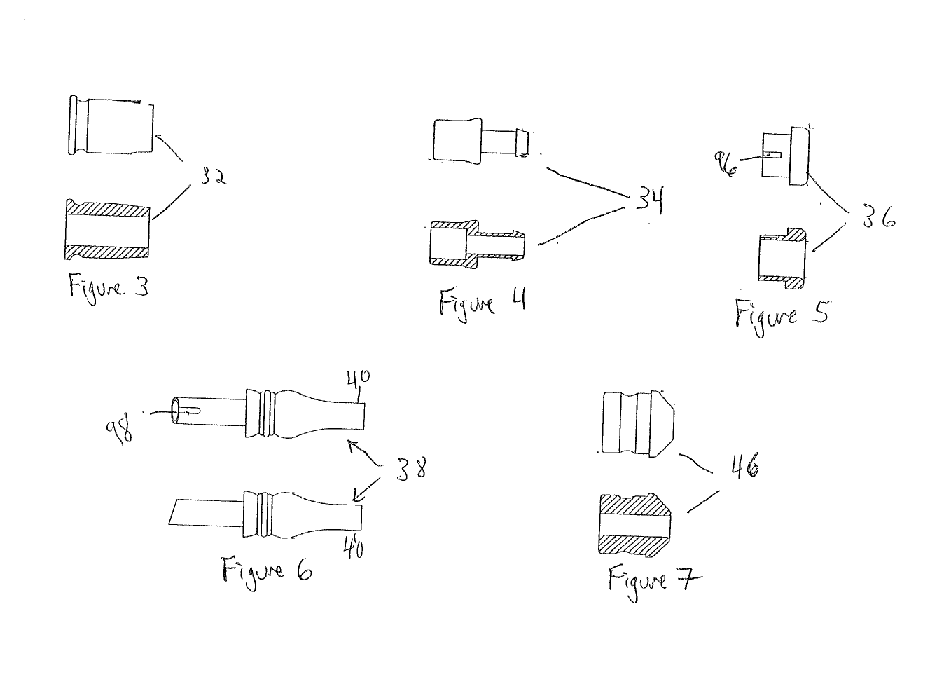

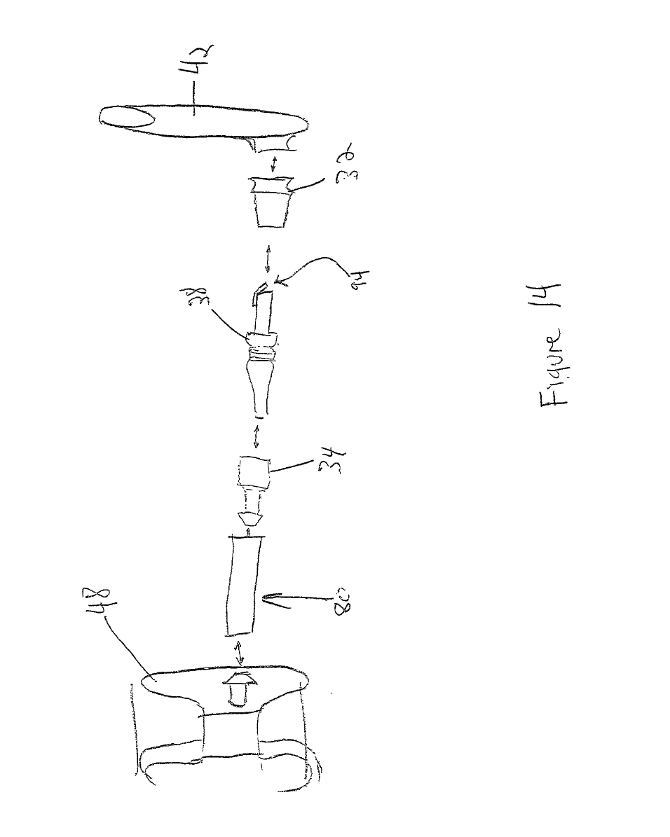

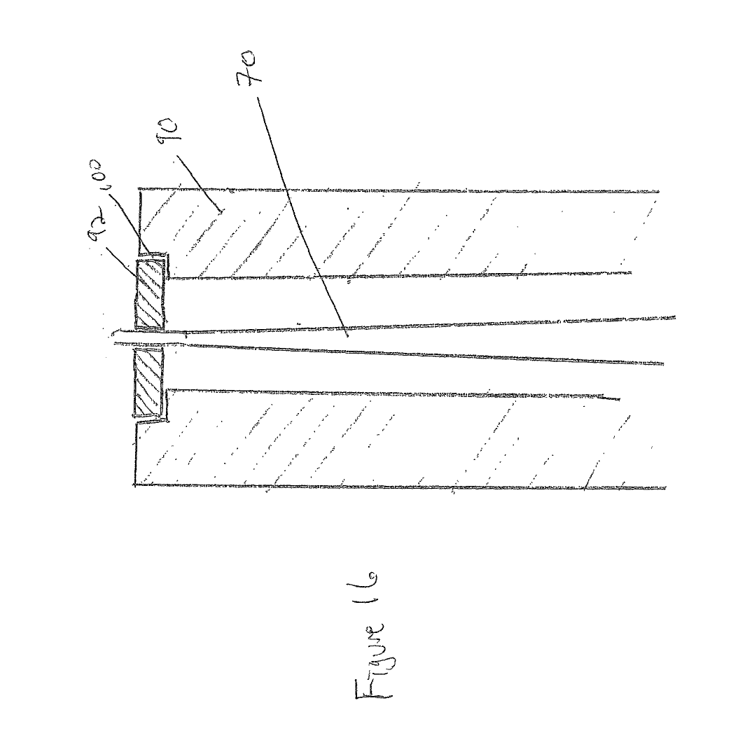

With reference now to FIGS. 1 and 2, a known chanter blank 10 is shown, with a perspective view in FIG. 1, and a cross-sectional view in FIG. 2. The knobs 12 would be cut off on three of the four sides leaving key mounts 66 as shown in FIG. 12. The key mounts 66 are for mounting keys 82. With reference now to FIGS. 15A and 15B, one option on a chanter 58 is one or more keys 82 that operate like the keys on a flute. These keys 82 would be for playing notes that are normally not available with the usual eight finger holes 68 on the chanter 58. For example, if a player wanted to have a natural F key, a hole 88 would be drilled in the chanter 58 between the E and F# finger holes 68, just below the key mount 66. A slot would be cut in the key mount 66 and the key 82 secured with a pin 84 through the key mount 66. A piece of leather (not shown) is then attached to the underside of the key 82 over the hole 84 to create a seal against the hole 84. A spring 86 is placed on the underside of the key 82 on the other end so the hole 84 can remain closed until the player pressed the key 82.

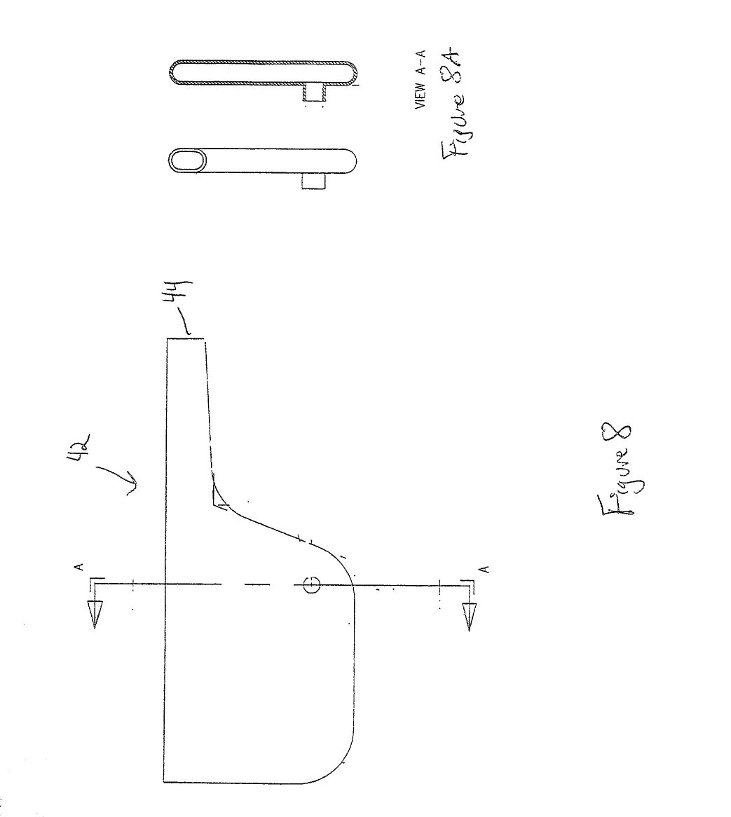

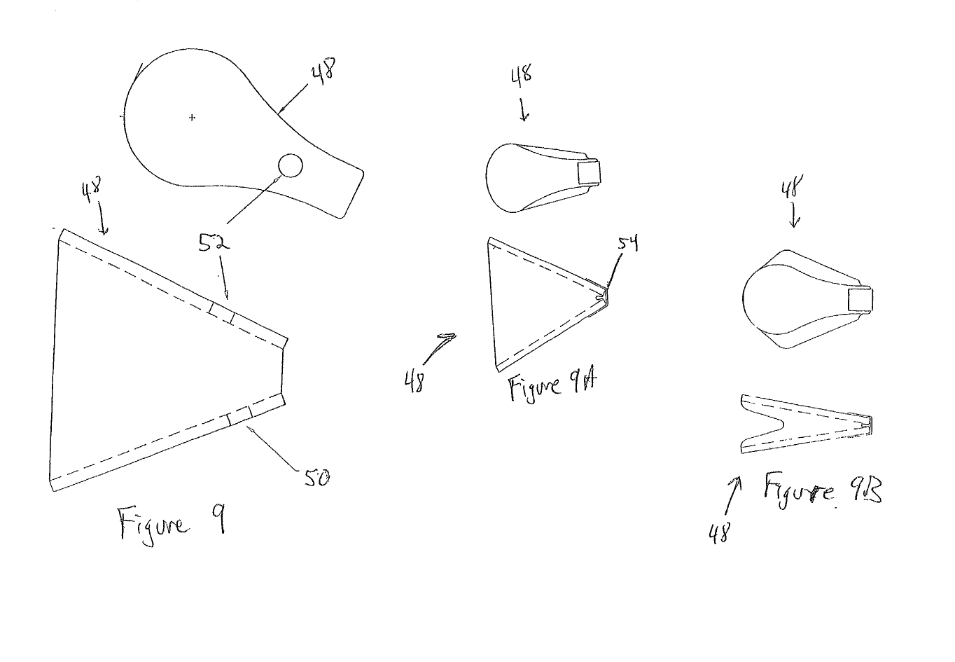

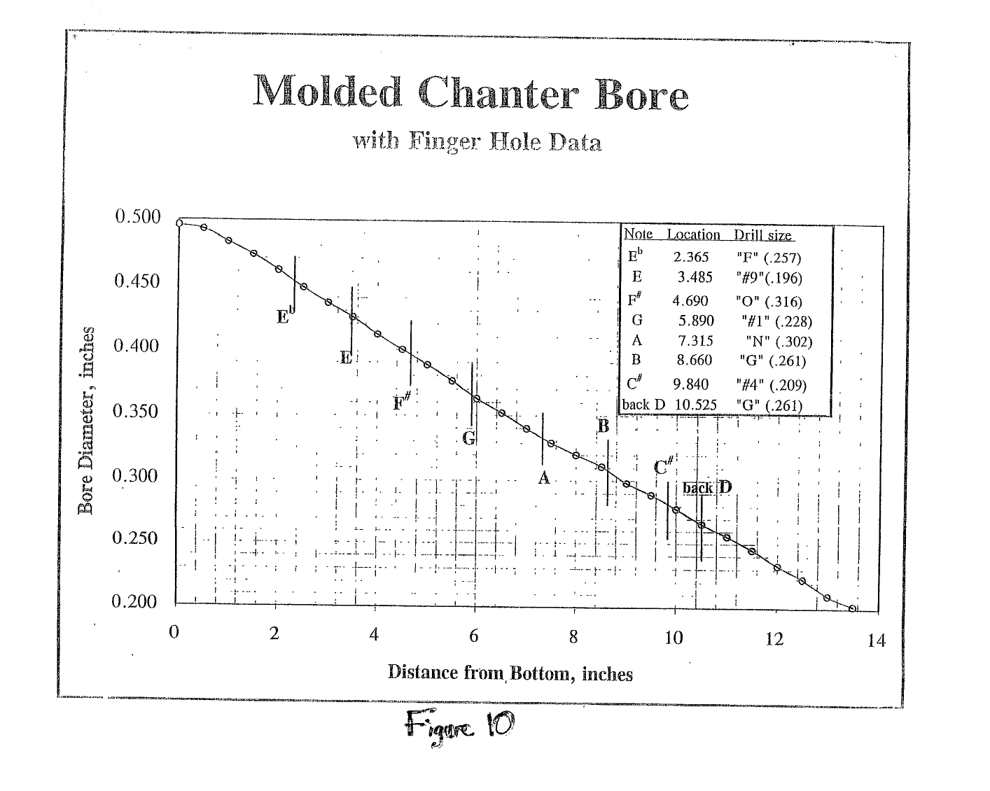

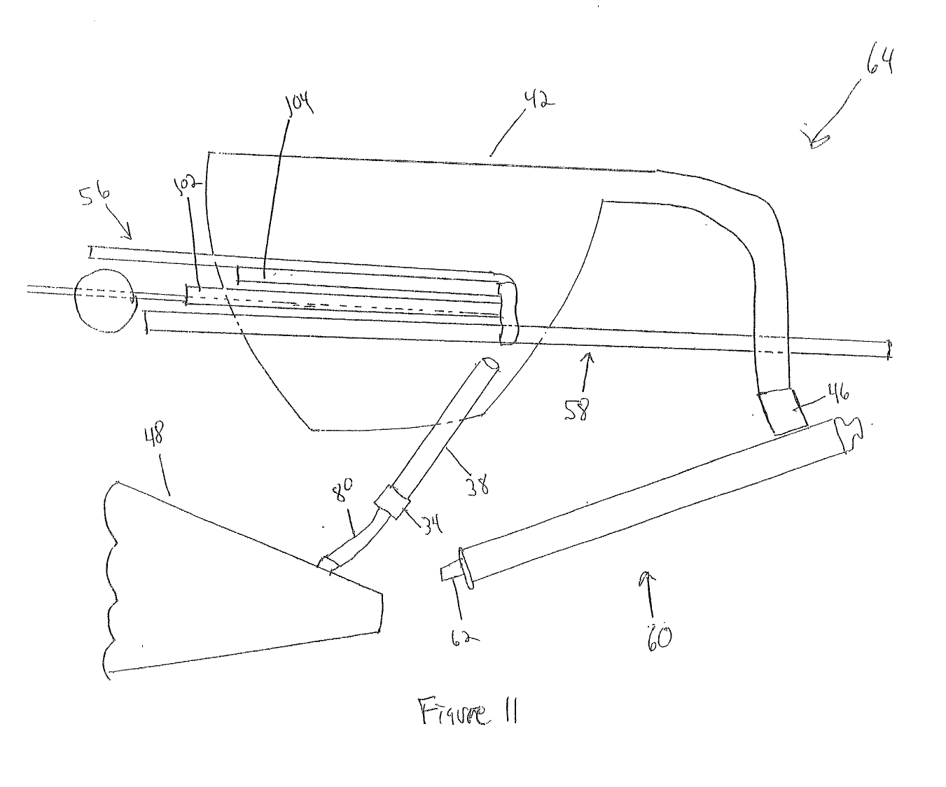

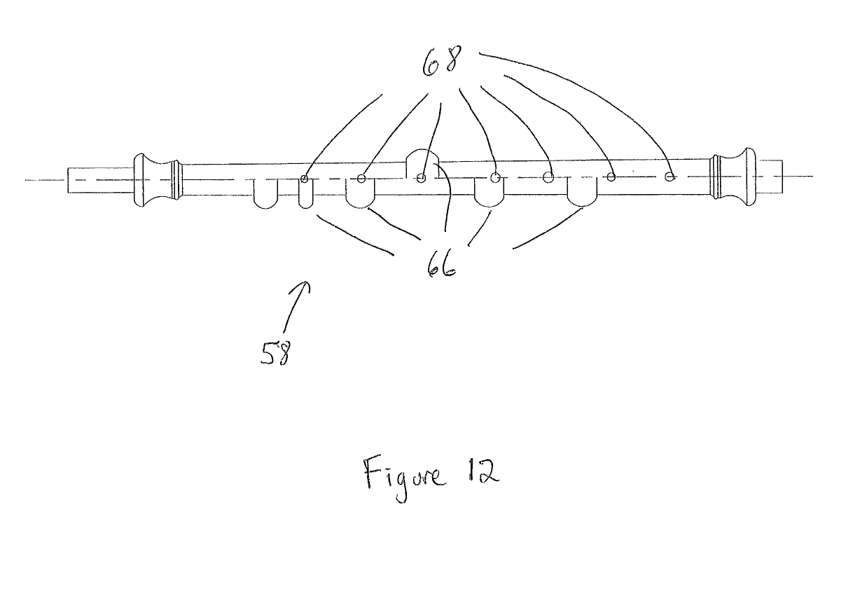

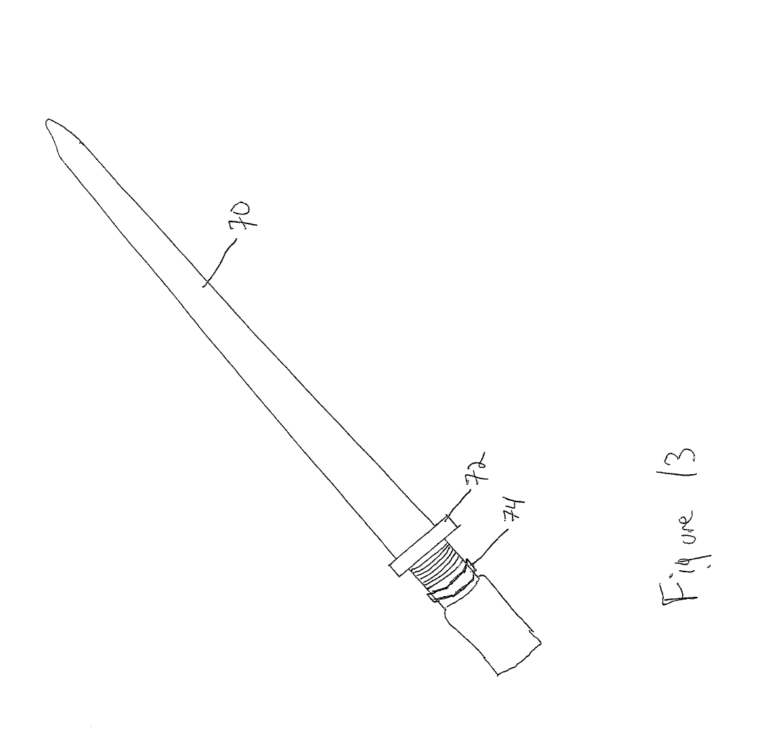

Finger holes 68 are then drilled into the chanter blank 10, and a decorative top and bottom mounts (not shown) will be added. The traditional method of creating a chanter is to use wood and drill all of the respective parts by hand. The current invention, however, allows the production of the chanter 58, and other parts, using a molding technique. FIGS. 3-7 show various parts that can be molded using the inventive technique, including, blowpipe stock 32, blowpipe receiver 34, bellows valve 36, blowpipe 38, valve notch 96, blowpipe notch 98, and chanter stock 46. The notches 96, 98 receives a flapper valve 94 (shown in FIG. 14). The flapper valve 94 allows air to flow through in one direction only.

Again, this invention is not limited to uilleann bagpipes, or the parts therefore. Any parts for any conical bore musical instrument, such as a flute, can be molded using the present invention. The further operation and construction of uilleann bagpipes are well known in the art, and, for the sake of brevity, will not be described herein.

With reference now to the method for producing the parts, the method used in this embodiment is thermoset molding, also called resin casting. In the past, others have used injection molding with thermoplastic to create various parts, but this thermoplastic warps and changes shape, and so is not accurate enough for a conical bore instrument. The dimensions of the conical bore are critical and often must be within 0.001-inch tolerance. Normally, the bore is reamed by hand so that the inner diameter is smooth. In order to accomplish this, different sized reamers must be used for each different section. The different reamers must be used because the conical bore must have a tapered shape in order to produce the proper sound.

The inventive resin casting method uses thermoset, which is similar to an epoxy. A low viscosity liquid is used during the process so that bubbles are not trapped in the mold. The low viscosity liquid, which in this embodiment is urethane (and in particular, ciba-geigy 6419). This particular kind of urethane is the hardest and pours easily into the mold. However, it is to be understood that any low viscosity liquid resin could be used in the current invention, as long as chosen using sound engineering judgment. The thermoset resin and resin casting give a lower shrinkage amount than thermoplastic injection molding. Shrinkage of the part causes warpage and variations in the critical bore diameters.

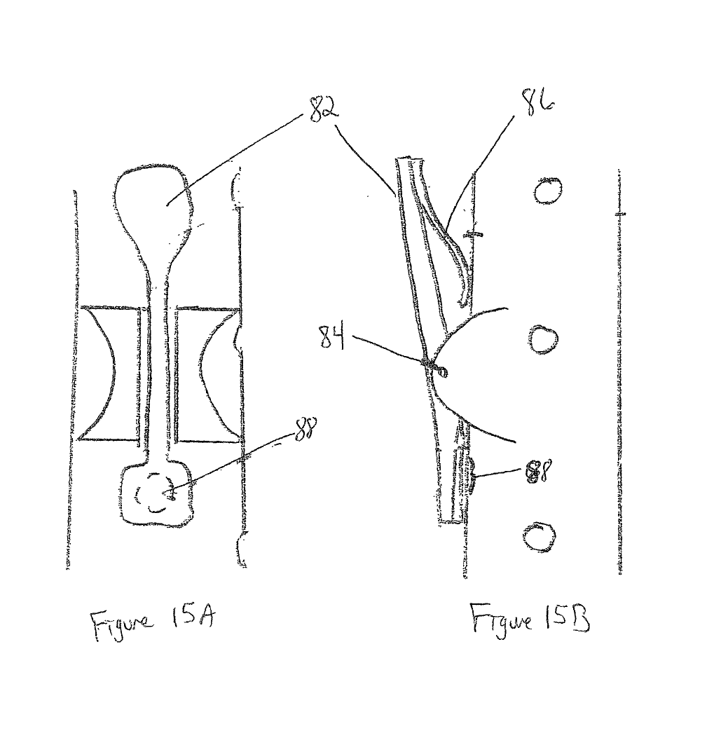

With reference now to FIG. 13, the core pin 70 has an ejector sleeve 72, a hex nut 74, and a threaded portion 76. The ejector sleeve 72 is located near the base of the core pin and above the threaded portion 76. The hex nut 74 is threadedly connected to the threaded portion 76 and is used to remove the molded part from the mold (not shown). The core pin 70 is created to the exact dimensions and diameter required for the conical bore (shown, but not referenced). Once the core pin 70 is manufactured with the proper dimensions, a perfect chanter, or bore, can be made each time. This allows quicker production of the parts, because the bore no longer must be reamed by hand.

With continuing reference to the inventive method and FIG. 16, the core pin 70 is covered with wax, or some other non-stick substance, and the mold 90 is closed around the core pin 70 with clamps (not shown). The mold 90 is placed in upright position, and the urethane is poured into the mold 90. A plug or donut 92 is placed on top of the mold 90, as shown in FIG. 16, to keep the core pin 70 centered while the resin cures. The hole in the donut 92 goes over the tip of the core pin 70 and the outside of the donut 92 centers on a counterbore 100 in the top of the mold 90. In this embodiment, there is a twenty-four hour cure period for the urethane. After the cure period, the chanter 58 is firmly stuck to the core pin 70. Therefore, the hex nut 74 is rotated upwardly, pushing the ejector sleeve 72 against the chanter 58, which releases the core pin 70 from the chanter 58.

Although this particular embodiment is described in relation to uilleann bagpipes, it is to be understood that this invention works equally well with any conical bore musical instrument.

Although this method has been described with relationship to molding a chanter 58, it is to be understood that it can be used for any parts for conical bore musical instruments, as long as chosen using sound engineering judgment.

In this invention, “wind instrument” encompasses any wind instrument that is typically not made of plastic.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method for producing an uilleann pipe chanter, the method comprising the steps of:
providing a core pin with a diameter matching a required diameter for an associated bore of the uilleann pipe chanter;
applying wax to the core pin;
closing a mold around the core pin;
placing the mold in an upright position;
pouring urethane into the mold;
securing the core pin in the center of the mold;
curing for at least twenty-four hours;
demolding the chanter; and,
rotating a hex nut, the hex nut pushing an ejector sleeve upward to remove the core pin from the chanter.

2. A method for producing parts for bagpipes, the method comprising the steps of:
pouring resin into a mold; and,
molding at least one part.

3. The method of claim 2, wherein the method further comprises the steps of:
waxing a core pin; and,
closing a mold around the core pin.

4. The method of claim 3, wherein molding at least one part comprises the steps of:
securing the core pin in the center of the mold; and, curing the resin for at least twenty-four hours.

5. The method of claim 4, wherein the method further comprises the step of:
rotating a hex nut, the hex nut pushing an ejector sleeve upward to remove the core pin from the chanter.

6. A bagpipe comprising:
a molded conical bore.

7. An uilleann bagpipe comprising:
a bellows;
a chanter;
a chanter reed;
finger holes;
key mounts;
a bellows valve;
a bellows stock;
a blowpipe receiver;
a blowpipe;
a blowpipe stock;
a chanter stock;
a wind cap;
a wind cap top;
drones;
regulators; and,
decorative mounts, wherein at least one of the above is made of thermoset resin.

8. The bagpipe of claim 7, wherein the chanter, key mounts, bellows valve, bellows stock, blowpipe receiver, blowpipe, blowpipe stock, chanter stock, wind cap, and wind cap top are made of thermoset resin.

9. The bagpipe of claim 6, wherein the instrument further comprises:
a molded chanter.

10. An apparatus for use in molding parts for musical instruments, the apparatus comprising:
a core pin;
an ejector sleeve slidably connected to the core pin; and,
ejecting means for moving the ejector sleeve up the core pin to remove the molded parts.

11. The apparatus of claim 10, wherein the connection between the core pin and the ejecting means is a threaded connection.

12. The apparatus of claim 11, wherein the ejecting means is a threaded nut.

13. The method of claim 3, wherein the method further comprises the step of:
providing a core pin, the core pin having a diameter which is equal to an associated diameter of an associated part.

14. The bagpipe of claim 7, wherein the finger holes are molded.

15. A wind instrument comprising:
a molded conical bore.
